(19) United States
(12) Patent Application Publication
(10) Pub. No.: US 2010/0289881 A1
(43) Pub. Date: Nov. 18, 2010

(54) CAMERA FOR MULTIPLE PERSPECTIVE IMAGE CAPTURING

(75) Inventor: Jin XU, Singapore (SG)

Correspondence Address: K&L Gates LLP, P. O. BOX 1135, CHICAGO, IL, 60690, US

(73) Assignee: Sony Corporation, Tokyo (JP)

(21) Appl. No.: 12/775,024

(22) Filed: May 6, 2010

(30) Foreign Application Priority Data
May 13, 2009 (SG) 200903332-5

(51) Int. Cl. H04N 13/02

(52) U.S. Cl. 348/47; 348/E13.074

(57) ABSTRACT

A multiple perspective image camera has a plurality of camera elements, and coupling elements for mechanically coupling the camera elements together pairwise, as a “chain”. Each camera element generates an image using light rays incident on the camera element 81 in a single respective plane, and the coupling elements maintain the positions of the camera elements such that the planes of the camera elements share a common direction. The image captured by each camera element is elongate in the common direction. The respective elongate images are combined to form a multiple perspective image, successive strips of the output image being derived from the successive camera elements. The camera includes a control system for controlling the camera elements to take their respective images simultaneously, and communication paths for extracting the elongate images from the respective camera elements.

### CROSS REFERENCES TO RELATED APPLICATIONS

The present application claims priority to Singapore Patent Application No. SG 200903332-5 filed on May 13, 2009, the contents of which are incorporated by reference herein.

### BACKGROUND

This present application relates to an apparatus for capturing multiple perspective images.

Unlike images captured using a traditional pin-hole camera, multiple perspective images contain samples of light rays from different view points within a single image. Capturing such images can create a lot of special visual effects that traditional methods of capturing single perspective images are not capable of. A typical multiple perspective image is shown in FIG. 1. There are many practical applications in the fields of arts, graphics, computer vision and recently 3D applications such as 3D display. Multiple perspective images are discussed in [1] (Jing Yi Yu, Leonar McMillan and Peter Sturm. Multiperspective modeling, rendering, and imaging. International Conference on Computer Graphics and Interactive Techniques. ACM SIGGRAPH ASIA 2008 courses).

Presently, such images are normally generated by mosaicing a plurality of perspective images or video sequences, which are captured by a camera moving along a specific track. This type of capture requires very high accuracy in the camera movement, storage of large amounts of data and time-consuming processing to generate the final image. Also, dynamic scenes cannot be shot with this type of capturing method.

A mirror based system and apparatus for generating such images, is disclosed in patents U.S. Pat. No. 6,795,109 and U.S. Pat. No. 6,665,003. Using curved mirrors, these systems enable the capture of a multiple perspective image with a single camera, thus allowing the capture of dynamic scenes. However, the systems are not flexible in the sense that they are designed only for a specific multiple perspective images, e.g. a stereo cyclograph. The mirror's dimension is designed for a specific task (e.g. if the object size changes, the mirror shape also needs to be changed), and it also requires high precision installation to ensure the quality of the captured image.

As described earlier, multiple perspective images are generated by mosaicing multiple single perspective images. Two common methods of obtaining images for the mosaics are “pushbroom” imaging (the term “pushbroom” is borrowed from satellite pushbroom imaging where a linear pushbroom camera is used) and “cross-slit” camera imaging. In pushbroom imaging, as shown in FIG. 2(a), all light rays for each image lie on a set of parallel planes and pass through a line (see FIG. 2(b)); by contrast, in a cross slit camera, as shown in FIG. 2(d), all light rays pass through two non-coplanar lines (see FIG. 2(e)). Examples of the resulting mosaiced images generated using these two methods are shown in FIGS. 2(c) and 2(f) respectively. Such images are normally generated from a collection of photographs or a videostream to effectively concatenate long, roughly planar scenes such as city streets. The final image will span a larger field of view than any single input image.

In principle, the same images can also be generated by moving a slit camera (having a slit and a film or imager, the slit having a fixed position relative to the film or imager) or a strip camera (also having a slit and a film or imager, but in which the relative position of the film/imager and the slit of the aperture varies at a constant speed) along a specific track. For the case of pushbroom and cross-slit above, the track is straight. However, FIG. 3 illustrates the working principle of a strip camera capturing a multiple perspective image. A design with digital camera is also reported in the experiment done by Andrew Davidhazy from School of PhotoArts and Sciences Rochester Institute of Technology (http://people.rit.edu/andpph/text-digital-strip-camera.html).

However, regardless of the type of camera used, these methods of capturing images are not capable of capturing dynamic scenes and this strongly limits the possible application of these systems.

In patents U.S. Pat. No. 6,795,109 and U.S. Pat. No. 6,665,003, a curved mirror based on careful optical design is disclosed to allow the capturing of multiple perspective images with a single fixed camera, thus creating dynamic scenes. FIG. 4 illustrates an example of one such system. A beam splitter is used to split the rays between two lens systems. The horizontal rays enter into the bottom lens system for the right eye. The upward rays are reflected by a mirror into the upper lens system for the left eye.

The main problem of the above system is its inflexibility and high precision requirements in during installation. As the mirror shape is based on careful optical design, it only works for one type of multiple perspective image, in this case stereo panorama. The placement of all the elements in this system, such as the mirror and camera, has to be done with high precision for successful capture of the image. Otherwise, the light rays will not be aligned with the designed optical paths and the captured image will be unusable.

Flexible camera arrays have been proposed in “Scene Collages and Flexible Camera Arrays” (by Y. Nomura, L. Zhang and S. K. Nayar, Proceedings of Eurographics Symposium on Rendering, June 2007). FIG. 5 shows a prototype of their system. This system is designed for scene collage applications, so it uses normal commercial 2D perspective cameras and the design does not take into consideration forming multiple perspective images. There are two disadvantages of applying this system into multiple perspective image capturing: 1) mosaicing is still needed to generate the final multiple perspective image, thus the requirement for storage and computer applies; and 2) the system does not take into consideration constraints (e.g. stereoscopic constraints for pairs of multiple perspective images) for forming useful multiple perspective images, thus it might be “too flexible” in the sense that critical information (e.g. 3D geometry) cannot be extracted from the resulting image.

### SUMMARY

The present application generally relates to a multiple perspective image camera has a plurality of camera elements, and coupling elements for mechanically coupling the camera elements together sequentially (that is, they are connected pairwise, as a “chain”) according to an embodiment. Each camera element generates an image using light rays incident on the camera element in a single respective plane, and coupling elements maintain the positions of the camera elements such that the planes of the camera elements share a common direction according to an embodiment. The respective image captured by each camera element is elongate in the common direction according to an embodiment.

In an embodiment, the respective images captured by the camera elements can then be combined to form a multiple perspective image, such that successive strips of the image are derived from successive ones of the camera elements. The camera may includes in an embodiment a control system for controlling the camera elements to take their respective images simultaneously, thus making possible a substantially instantaneous image of a dynamic scene.

The camera further includes communication paths for extracting the elongate images from the respective camera elements in an embodiment. For example, the camera includes a processor for combining the elongate images together to form the multiple perspective image, or alternatively the images may be transmitted out of the camera and the multiple perspective image formed there according to an embodiment.

In an embodiment, the mechanical coupling of the camera elements allows their relative angular positions to be modified. By arranging the chain of camera elements into various shapes, different types of multiple perspective images such as pushbrooms and cyclographs can be captured. Optionally, a drive mechanism is provided for modifying the relative positions of the camera elements.

In an embodiment, each camera element forms only a single strip-image. Such camera elements may contain a single slit, a focusing mechanism and a row of light sensitive elements arranged to receive respective light rays passing through the slit and focusing mechanism. Optionally, a light sensitive element drive mechanism is provided (typically in addition to the drive system for moving complete camera elements) for modifying the relative positions of the light sensitive elements (and perhaps other elements) within the camera elements.

In another embodiment, the camera elements are capable of forming multiple slip-like images. For example, the camera elements include a single slit and multiple rows of light sensitive elements parallel to the slits, such that each row of light sensitive elements is sensitive to light rays in a respective plane and forms a respective elongate image in an embodiment. Optionally, a drive mechanism may be provided for modifying the relative positions of the multiple planes in an embodiment.

The coupling elements include, but are not limited to, hinges, elastic joints, ball and socket connections, and the like. For example, in the case that the coupling elements are hinges which join respective pairs of the camera elements, the axis of the hinge which connects any given pair of the camera elements lies in the common direction, and is parallel to the row(s) of light sensitive elements in each of the pair of camera elements, so that as the pair of camera elements mutually rotate about the hinge, the extension direction of the row(s) of light sensitive elements remains parallel to the hinge axis.

In an embodiment, the present application provides a camera element for use in the multiple perspective image camera.

Additional features and advantages are described herein, and will be apparent from the following Detailed Description and the figures.

### BRIEF DESCRIPTION OF THE FIGURES

FIG. 1 is a multiple perspective image;

FIG. 2 is composed of FIGS. 2(a) to 2(f), where FIG. 2(a) shows the operating principle of a known pushbroom imaging system, FIG. 2(b) shows the light ray planes captured by a pushbroom imaging system, FIG. 2(d) shows the operating system of a known cross-slit camera, FIG. 2(e) shows the light ray planes captured by a cross-slit camera, and FIGS. 2(c) and 2(f) show images produced by the pushbroom camera and cross-slit camera;

FIG. 3 shows a known strip camera;

FIG. 4 illustrates a known system for simultaneous capture of both left and right panoramas;

FIG. 5 shows a known flexible camera array;

FIG. 6 is composed of FIGS. 6(a) and 6(b), which respectively show schematically an embodiment of the application in a configuration (FIG. 6(a)) in which it takes a pushbroom image, and (FIG. 6(b)) a cyclograph image;

FIG. 7 is composed of FIG. 7(a) and FIG. 7(b), which respectively show how the embodiment of FIG. 6 captures images when in the configuration of FIG. 6(a) and FIG. 6(b);

FIG. 8 is composed of FIG. 8(a) which shows a more detailed front view of a single camera element in the embodiment of FIG. 6, and FIG. 8(b) which shows the internal structure of the camera element;

FIG. 9 illustrates the internal structure and operation of a single camera element in a second embodiment of the application; and

FIG. 10 illustrates the operation of the second embodiment of the application;

FIG. 11 illustrates the internal structure and operation of a single camera element in a third embodiment of the application;

FIG. 12 illustrates the operation of the third embodiment of the application;

FIG. 13 a configuration of the third embodiment of the application which creates a stereoscopic cyclograph image pair; and

FIG. 14 shows a flow chart of for processing images captured using the embodiments of the present application.

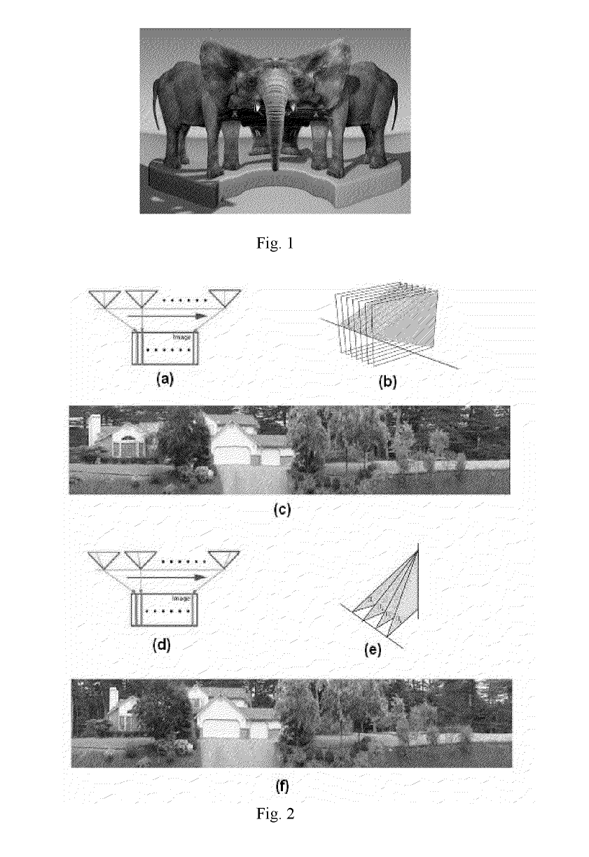

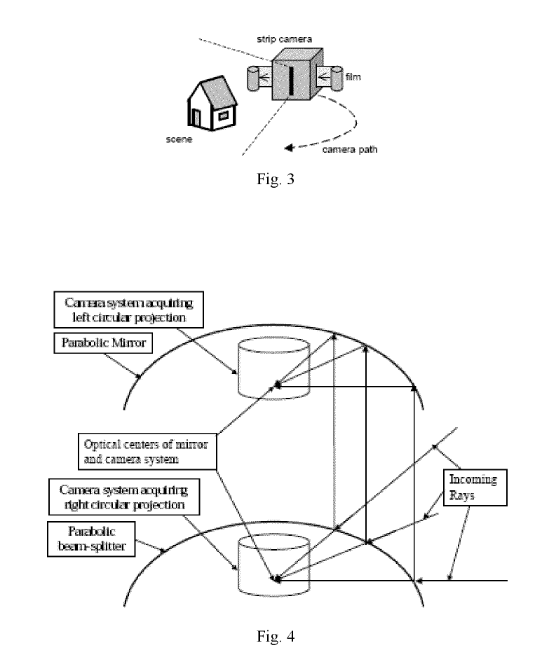

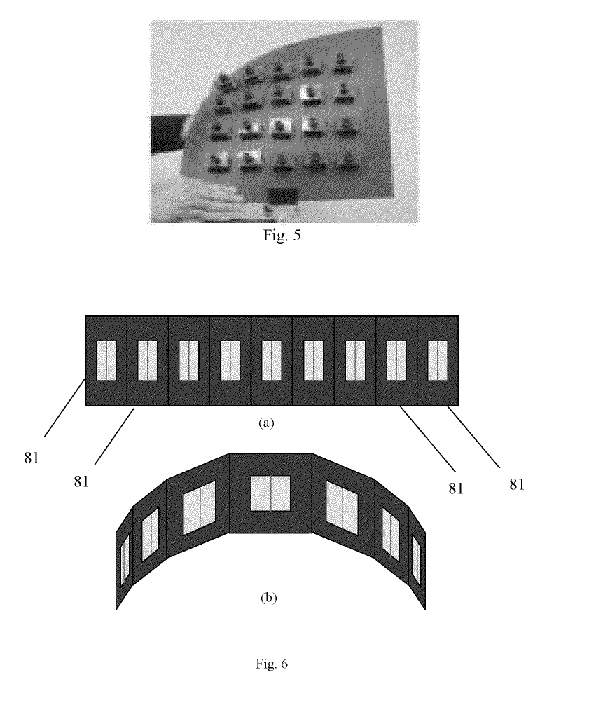

### DETAILED DESCRIPTION

The present application will be described below in greater detail with reference to the drawings according to an embodiment.

A multiple perspective camera which is a first embodiment is illustrated in FIG. 6. The camera includes a plurality of camera elements 81, which are mutually hinged together pairwise, to form a chain. FIG. 6(a) shows the camera in a first configuration in which the camera elements 81 all lie in a common plane, and the camera captures a pushbroom image. FIG. 6(b) shows the camera in a second configuration in which the chain of camera elements 81 extends in a curve, and the camera captures a cyclograph image. Each camera element 81 takes a single image which is elongate in the vertical direction of FIG. 6(a), which is also the extension direction of the hinges between the camera elements 81.

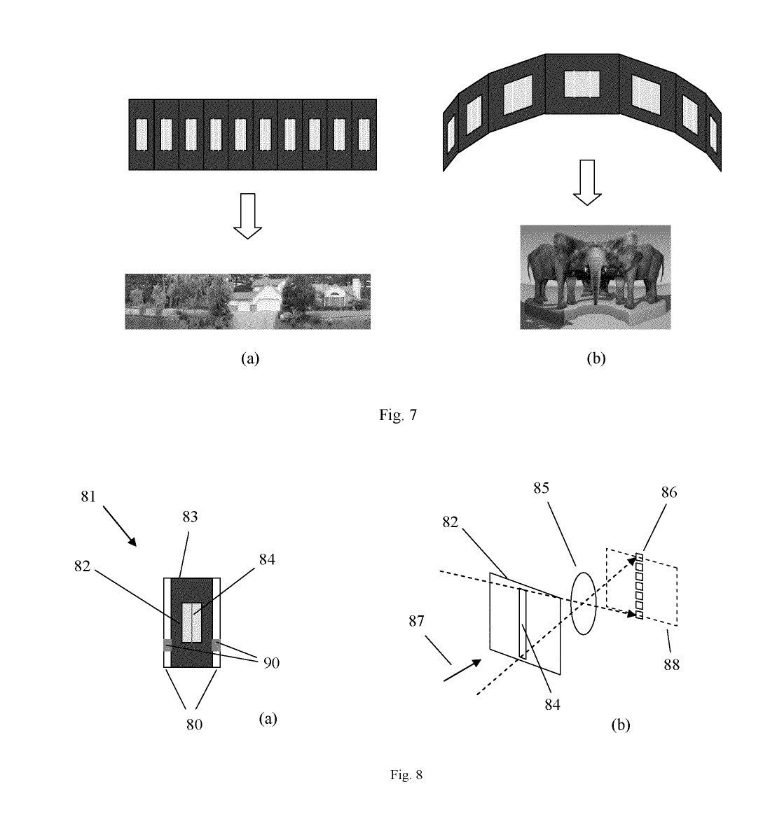

A common control system transmits respective control signals to the camera elements substantially simultaneously, and upon receiving the control signals, the camera elements 81 capture a respective elongate image. The images are then transmitted out of the camera elements 81 along communication paths to a processor (located either within the camera or outside), where they are combined as strips of a multiple perspective image. FIG. 7(a) shows an image as captured by the camera when in the configuration of FIG. 6(a), and FIG. 7(b) shows an image captured by the camera when in the configuration of FIG. 6(b).

FIG. 8(a) shows a more detailed front view of a single camera element 81, while FIG. 8(b) shows the internal construction of the camera element 81. The camera element 81 of this system includes a support structure 83, of which a central portion is a plate 82 defining a slit 84. The plate 82 is in front of a focusing device 85 and a digital linear optical sensor 86 which is a row of light sensitive elements, so that only the light rays 87 that go through the slit 84 are captured by the linear sensor 86. The linear sensor 86 has a fixed position relative to the slit 84, the slit 84 and linear sensor 86 being opposite with respect to the focusing device 85.

The first embodiment is different from a traditional analog “strip camera” in that each linear optical sensor 86 can be controlled independently with a digital control signal, making it possible to record different light rays 87 (e.g. simultaneously) with a plurality of such sensors 86 in respective camera elements 81. This enables the proposed system to capture dynamic scenes that are beyond the ability of the traditional “strip camera”.

In the first embodiment the camera element 81 includes coupling elements 80 for mechanically coupling the camera element 81 to further camera elements 81 to each respective side. The coupling elements 80 permit each pair of adjacent camera elements 81 to hinge relative to each other, so that the complete array of camera elements 81 forms a flexible array of camera elements 81. All the hinge axes are parallel to the slit 84. When an image is captured using this camera element, the light rays lie in a plane which includes the vertical direction and which is perpendicular to the image plane 88.

The camera array can be bent into different geometrical shapes for capturing different types of multiple perspective image. The pairs of camera elements 81 are also electrically coupled pairwise by electrical connectors 90. These permit control signals and power to be transmitted to the camera elements 81 and define communication paths for transmitting the images captured by the camera elements 81 out of the device to a processor, where the images are concatenated sequentially to form a 2D image. Optionally, the ordering of data can be facilitated by arranging that the images carry IDs assigned to each respective camera element.

The control signals may causes the camera element 81 to capture a single corresponding image. Alternatively, the control signals may indicate the starting and ending time of the capturing process, and the camera element 81 may be arranged to generate images continuously or periodically between these times. The camera element 81 can obey these control signals using a mechanical shutter (not shown) or by electrical activation/deactivation of the optical sensor 86.

Optionally, the control signals may cause all the camera elements to generate images simultaneously. Alternatively, each camera element 81 may be controlled independently for special viewing effects.

A drive mechanism may be provided, e.g. under the control of the control system, to reconfigure the camera (e.g. between the configurations of FIGS. 6(a) and (b)). Alternatively, the reconfiguration may be possible manually.

We now turn to a second embodiment. This embodiment also has a configuration as illustrated in FIGS. 6 and 8(a), so corresponding elements will be given the same reference numerals, but the construction of the camera elements 81 is different. Due to this difference the camera is capable of generating cross-slit images even when the camera elements 81 are in the “parallel” configuration of FIG. 6(a). As shown in FIG. 9, a camera element 81 of the second embodiment includes a drive mechanism for changing the configuration (e.g. position in the 3D space within the camera element 81) of focusing device 85 and optical sensor 86 relative to the slit 84 can be controlled with an additional input control signal. The variation in these positions moves the plane 87, allowing rays from different directions to pass through the slit 84 to the optical sensor 86 (note however that the modified plane 87 still contains the direction which is vertical in FIG. 6(a)). The control signal can be generated by a control device (e.g. a computer) and be sent to each camera element 81 through the electrical inter-connections 90. Different control signals can be generated for different camera elements 81, e.g. by assigning respective Ids to each of the camera elements, and transmitting control signals to all the camera elements which contain one of the IDs, such that only one of the camera elements recognises its ID and responds to the control signal.

Capturing cross-slit images using the second embodiment requires: 1) flexibility in selecting incoming plane of rays 87; and 2) knowledge of the relative position of each element 81 in the array. FIG. 9 illustrates the selection of ray planes 87 with a control signal sent to the focusing device 85 and optical sensor 86. With the input the control signal, the focusing device 85 and optical senor 86 will adjust their positions correspondingly so that rays from a specified direction are captured. Thus the plane 97 in which incoming light rays must lie to reach the optical sensor 86, changes.

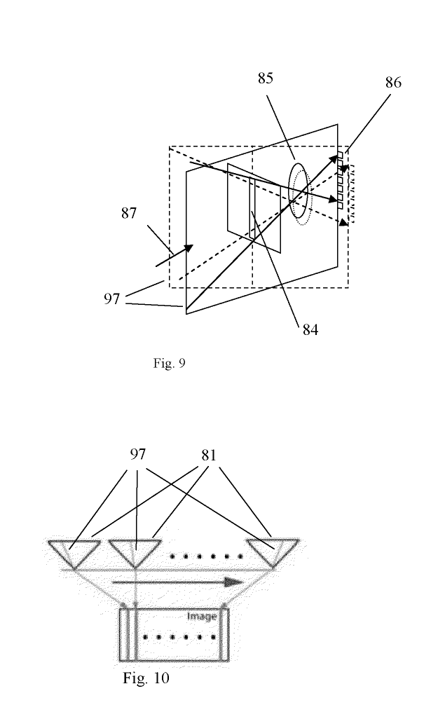

An example of this is shown in FIG. 10. Using additional sensors, it is possible to identify the relative position of each element with respect to the center of the whole array. Different control signals can then be sent to each element depending on its position in the array for the capturing of cross-slit images. For example, the element at the centre of the array will capture light rays that are perpendicular to the image plane; the elements further away from the centre will be capturing rays that are increasingly oblique to the image plane.

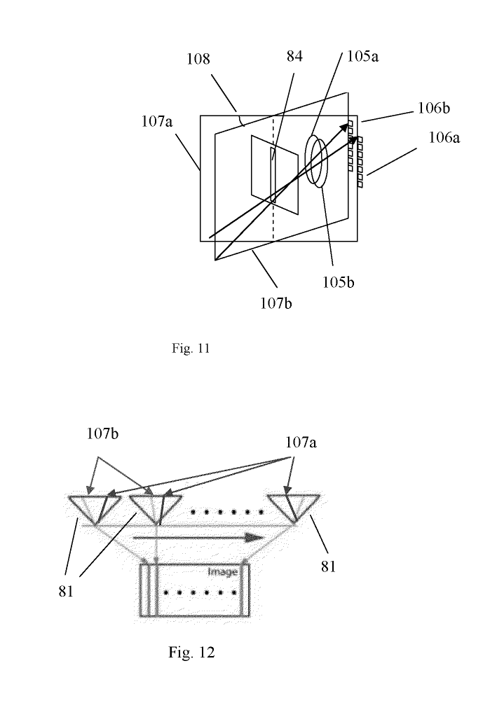

In a third embodiment shown in FIG. 11, the basic element is able to capture light rays in a plurality of “planes” in the same shot, thus creating stereoscopic images. Elements having the same construction as in FIG. 9 are given the same reference numerals. In this embodiment, two focusing devices 105a, 105b and two linear optical sensor arrays 106a, 106b are provided. These optical sensors 106a, 106b capture rays from two different directions through the slit 104, as shown in FIG. 10. That is, each optical sensor 106a, 106b is associated with a different respective plane 107a, 107b including that sensor and the slit 84. This allows the capture of a stereoscopic image pair simultaneously using one element. The two ray planes 107 are symmetric with regard to the slit 104 and can be controlled using a single signal. This signal indicates the angle 108 between these two ray planes 107 for capturing stereoscopic image pairs with different configurations. This control signal is generated from a control system (e.g. a computer) and sent to each camera element 81 through the inter-connections between them. It is also possible to use two independent signals to control each ray plane 107a, 107b for more flexibility.

Although the third embodiment has two focusing devices and optical sensors, the present application is not limited in this aspect. More than two independent focusing devices with corresponding optical sensors can be provided. They will be controlled by respective control signals to capture light rays with different incident angles with respect to the image plane as shown in FIG. 10. FIG. 12 shows an example of controlling each element to capture stereoscopic cross-slit images using the third embodiment of the application with two optical systems/linear sensor pairs.

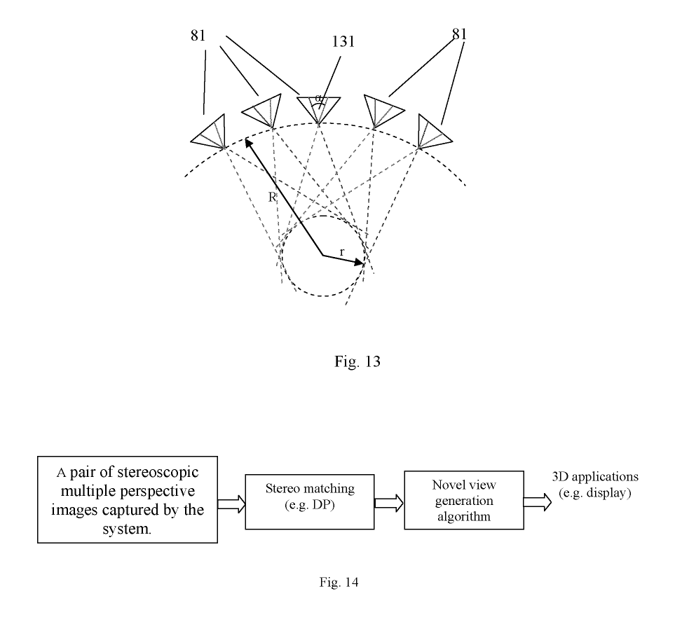

FIG. 13 illustrates how the third embodiment of the application may be configured to produce a stereoscopic cyclograph image pair. The angle 131 between two planes of light rays in each element 81 should be the same. The angles 131 determine the locus of the rays as illustrated in FIG. 13 (for the case of a circular setup, the relationship is r=Rsin (α/2). This arrangement satisfies the general epi-polar constraints for stereoscopic images as shown in [2] (Steven M. Seitz and Jiwon Kim. The Space of All Stereo Images. International Journal of Computer Vision, Marr Prize Special Issue, vol. 48, no. 1, pp. 21-38, 2002).

FIG. 14 shows flowchart of a method of using the multiple perspective images captured by the third embodiment . A stereoscopic image pair is generated by assembling the data captured by each element of the system. Stereo matching (e.g. by dynamic programming—DP) can then be done to infer the 3D geometry information from the stereoscopic pair. This information can be further used to generate a novel view (possibly perspective) for 3D applications (e.g. a ray-reconstruction type 3D display).

With the present application, various types of multiple perspective images can be captured with a simple setup. The present application is designed to be modular with each independent element connected hingeably (and preferably releasably) to other elements. This enables the array of slit-cameras to be set up in different shapes for the capturing of different types of multiple perspective images. In addition, dynamic scenes can be easily captured, as well as obtaining stereoscopic information of the scene through the capturing of image streams on each element.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A multiple perspective image camera comprising:
a plurality of camera elements, each camera element being arranged to capture at least one elongate image generated using light rays incident on the camera element in a single respective plane;
a plurality of coupling elements for mechanically coupling the camera elements together in a sequence; and
a control system for controlling the plurality of camera elements to capture respective elongate images;
the planes of the camera elements sharing a common direction.

2. A multiple perspective image camera according to claim 1, further comprising a plurality of communication paths for transmitting the corresponding elongate images out of the camera elements.

3. A multiple perspective image camera according to claim 2, further comprising a processor for receiving the elongate images from the plurality of camera elements and combining, the elongate images into an image in which the elongate images form respective strips of the image.

4. A multiple perspective image camera according to claim 1, wherein the coupling elements permit each pair of neighbouring camera elements to hinge about an axis lying in the common direction.

5. A multiple perspective image camera according to claim 1, further comprising a drive mechanism for displacing the camera elements.

6. A multiple perspective image camera according to claim 1, wherein each camera element includes a slit, at least one row of light sensing elements parallel to the slit, and a focusing device between the slit and the at least one row of light sensing elements.

7. A multiple perspective image camera according to claim 6, wherein a single row of light sensing elements is provided, and further comprising a light sensitive element drive means for displacing the row of light sensitive elements relative to the slit.

8. A multiple perspective image camera according to claim 6, wherein each of the camera elements includes a plurality of said rows of light sensing elements, each row of light sensing elements being parallel to the slit.

9. A multiple perspective image camera according to claim 8, wherein each of the camera elements further includes light sensitive element drive means for displacing the rows of light sensitive elements relative to each other and to the slit.

10. A multiple perspective image camera according to claim 9, wherein the light sensitive element drive means displaces the rows light sensitive elements while maintaining a symmetrical relationship between the rows of light sensitive elements and the slit.

11. A camera element for a multiple perspective image camera, the camera element being arranged to capture at least one elongate image using light rays incident on the camera element in a single respective plane, and comprising:
one or more coupling elements for coupling the camera element to an adjacent camera element, and a control signal input, the camera element to other camera elements; and
an input for receiving a control signal for controlling the camera element.

12. A multiple perspective image formation system comprising a multiple-image camera including;
a plurality of camera elements, each camera element being arranged to capture at least one elongate image generated using light rays incident on the camera element in a single respective plane;
a plurality of coupling elements for mechanically coupling the camera elements together in a sequence; and
a control system for controlling the plurality of camera elements to capture respective elongate images;
the planes of the camera elements sharing a common direction; and
a processor for generating a three-dimensional model from the outputs of the camera elements, and generating a 3-D display using the three-dimensional model.
